(19) United States
(12) Patent Application Publication
(10) Pub. No.: US 2009/0050249 A1
(43) Pub. Date: Feb. 26, 2009

(54) Anti-slipping device for dual tires

(75) Inventor: Dae Kyun Shin, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SCS Systems, Ganseo-Gu (KR)

(21) Appl. No.: 11/663,020

(22) PCT Filed: Feb. 16, 2007
(86) PCT No.: PCT/KR2007/000843

§ 371 Date: Mar. 15, 2007

(51) Int. Cl. B60C 27/12

(52) U.S. Cl. 152/213 R

(57) ABSTRACT

Provided is an anti-slipping device for dual tires including: a plurality of spike members 100 which includes an insertion plate 110 bent in a trapezoidal shape to be inserted between the dual tires 10, and a close-contact plate 120 integrally and flatly extending from opposite sides of the insertion plate 110 to closely contact each surface of the dual tires 10; a belt 200 for connecting the insertion plates 110 of the plurality of spike members 100 to each other; and a fastener 300 detachably coupled to opposite ends of the belt 200 to adjust tension of the belt, wherein a plurality of first and second spikes 121 and 122 protrude from an outer surface of each close-contact plate 120 of the plurality of spike members 100 at regular intervals to be different in height from each other to prevent friction with a road surface and slipping, thereby stably providing running performance and braking power to minimize a risk of a slipping accident.

### TECHNICAL FIELD

The present invention relates to an anti-slipping device for dual tires, and more particularly, to an anti-slipping device for dual tires used as a rear wheel of a large car, in which a plurality of spike members connected by a belt are inserted between the dual tires at regular intervals, and opposite ends of the belt are tightly fastened together by a fastener, thereby stably providing running performance and braking power to minimize a risk of a slipping accident.

### BACKGROUND ART

In general, a chain, an integral chain that cables or urethane blocks are interconnected, a snow-tread tire, a spike tire, etc. are prepared for a snowy or icy road.

In the case of the chain or integral chain, they damage the road surface and make a pothole on the road, so that use of the chain or integral chain is restricted on expressways to prevent an accident due to the pothole from happening.

Further, a mounting work of the chain or integral chain is very complicated and difficult, for example, the wheel should be rotated forward and backward for mounting them thereon. It is difficult for even a burly man to normally and tightly mount the chain on the wheel on a cold winter's day. Thus, the chain may be broken away from the wheel or lost while running, thereby causing an accident. Also, the chain may be so damaged that it cannot be reused.

Meanwhile, if the chain or integral chain is mounted on an inside tire of dual tires, the mounting work is allowed under the condition that the dual tires are all taken out from a vehicle or the vehicle is jacked up. Further, the chain should be intertwined on the whole surface of the tire, so that it takes at least 30 minutes to 1 hour to mount the chain on the wheel. The chain itself tips the scales at 50 kg×2=100 kg, and the trip distance cannot exceed 100 km.

In the case of the snow tire or spike tire, it is difficult to quickly replace a normal tire with the snow or spike tire on the road according to sudden weather changes, so that a user has to drive the vehicle dangerously in order to take the vehicle to a garage. Also, the snow and spike tires are relatively expensive and decrease fuel efficiency, so that they are not economical.

To solve these problems, an idea such as a pad-type snow chain which is connected in a straight line has been proposed, but there are many problems to apply it to a practical vehicle. If the straight-line connection pad is applied to the vehicle, it increases a risk of an accident in comparison the existing chain.

For example, abrasion resistance of a saw-tooth provided in the pad is bad, so that the saw-tooth is easily abraded by running of about 20-30 km. Thus, this pad cannot be used as the snow chain. Further, a contact rate between the saw-tooth spike and the road is so high that it runs afoul of the law.

Further, a curved angle of the pad closely-attached between the dual tires is so large that the close-contact between the pad and the tire is inferior if a space between the dual tires is narrow, thereby damaging the tires or breaking the chain.

Also, when the chain is fastened at the last stage of the mounting work, a fastener is unstable and causes the chain to be easily loosed or broken during running. Due to such problems, the straight-line connection pad requires a lot of complements so as to be applied to the practical vehicle.

### DISCLOSURE

### [Technical Problem]

First, the present invention is directed to an anti-slipping device for dual tires, in which double spikes that are different in height protrude from an outer surface of a spike member, i.e., a contact surface in contact with a road surface, so that the double spikes are prevented from abrasion and thus semipermanently usable, thereby minimizing road damage and increasing friction between the tire and the road surface to enhance braking power.

Second, the present invention is directed to an anti-slipping device for dual tires, in which an inner surface of a spike member, i.e., a circumferential surface of a contact surface in contact with a surface of the tire is formed with a fitting part bent at a predetermined angle, so that close-contact between the device and the tire increases to thereby prevent the wheel from idling and enhance driving comfort.

Third, the present invention is directed to an anti-slipping device for dual tires, in which an outer surface of a spike member, i.e., a contact surface in contact with a road surface is formed with at least one curved part such as an embossing pattern, so that contact between a circumferential area of the spike member and the road surface is minimized while the tire rolls, thereby effectively preventing the spike member from bending at high speed running.

Fourth, the present invention is directed to an anti-slipping device for dual tires, in which a plurality of spike members are coupled to a synthetic resin belt at regular intervals, thereby preventing noise and lessening impact while running; effectively preventing the spike member from tangling; and decreasing weight to enhance convenience of mounting and portability.

Fifth, the present invention is directed to an anti-slipping device for dual tires, in which opposite ends of a belt having a plurality of spike members fixed thereto are detachably coupled with a length-adjustable fastener, so that it is convenient for a user to mount/remove the device on/from the tire and to more tightly fasten the device.

Sixth, the present invention is directed to an anti-slipping device for dual tires, in which a holding band member and a pair of hook rings are detachably coupled to externally surround a fastener, thereby effectively preventing a handle of the fastener from moving at high speed running.

### [Technical Solution]

To solve the above-subject matter, according to an aspect of the present invention, an anti-slipping device for dual tires includes: a plurality of spike members 100 which includes an insertion plate 110 bent in a trapezoidal shape to be inserted between the dual tires 10, and a close-contact plate 120 integrally and flatly extending from opposite sides of the insertion plate 110 to closely contact each surface of the dual tires 10; a belt 200 for connecting the insertion plates 110 of the plurality of spike members 100 to each other; and a fastener 300 detachably coupled to opposite ends of the belt 200 to adjust tension of the belt, wherein a plurality of first and second spikes 121 and 122 protrude from an outer surface of each close-contact plate 120 of the plurality of spike members 100 at regular intervals to be different in height from each other to prevent friction with a road surface and slipping.

The plurality of first spikes 121 may be lengthwise arranged on a middle of the close-contact plate 120 at regular intervals, and include a hole 121a penetrating the close-contact plate 120 and a cylindrical projection 121b integrally protruding from an outer circumference of the hole 121a.

A top surface of the projection 121b may be formed with an uneven part 121c having a regular or irregular saw-tooth for increasing friction with the road surface.

The plurality of second spikes 122 may be provided higher than the plurality of first spikes 121 by a predetermined height.

The predetermined height may range from 1 mm to 3 mm.

The plurality of second spikes 122 may have a cone shape to minimize a contact rate with the road surface.

The plurality of second spikes 122 may be arranged in a zigzag pattern between the plurality of first spikes 121.

An outer circumference of the close-contact plate 120 of the spike member 100 may be provided with a plurality of fitting parts bent to contact the surface of the tire for anti-slipping and close-contact.

The outer surface of the close-contact plate 120 of the spike member 100 may be provided with at least one protruded first curved part 124 having an embossing pattern to prevent the spike member from bending.

A pair of second curved parts 125 each having a V-shape may protrude from opposite positions where the insertion plate 110 and the close-contact plate 120 of the spike member 100 are connected, to prevent the spike member 100 from bending.

The fastener 300 may include a belt fastener 310 including a holding belt 313 and an adjusting belt 314 and having an adjustable length; and first and second locking rings 320a and 320b detachably coupled to the holding and adjusting belts 313 and 314, respectively, to be releasably locked into the insertion spaces 210a and 210b formed in opposite ends of the belt 200.

The anti-slipping device may further include a holding band member 400 detachably coupled to the fastener 300 while covering an exterior of the fastener 300 and preventing the fastener 300 from moving; and first and second hook rings 500a and 500b lengthwise movably coupled to the belt 200 between two spike members 100 provided in the opposite ends of the belt 200, and detachably coupled to the holding band member 400.

The holding band member 400 may include: an expandable rubber band 410 having a predetermined length; and first and second connection rings 420a and 420b coupled to opposite ends of the rubber band 410. The first and second connection rings 420a and 420b may include first and second bodies 421a and 421b having [symbol] -shapes and coupled to the opposite ends of the rubber band 410; and first and second bending ends 422a and 422b integrally extending from opposite ends of the first and second bodies 421a and 421b and bent in U-shapes to be hooked to the first and second hook rings 500a and 500b.

The first and second hook rings 500a and 500b may include rectangular rings perpendicularly curved at opposite ends thereof to have a [symbol] -shape.

### [Advantageous Effects]

As described above, an anti-slipping device for dual tires according to the present invention has the following advantages:

First, double spikes that are different in height protrude from an outer surface of a spike member, i.e., a contact surface in contact with a road surface, so that the double spikes are prevented from abrasion and thus semipermanently usable, thereby minimizing road damage and increasing friction between the tire and the road surface to enhance braking power.

Second, an inner surface of a spike member, i.e., a circumferential surface of a contact surface in contact with a surface of the tire is formed with a fitting part bent at a predetermined angle, so that close-contact between the device and the tire increases to thereby prevent the wheel from idling and enhance driving comfort.

Third, an outer surface of a spike member, i.e., a contact surface in contact with a road surface is formed with at least one curved part such as an embossing pattern, so that contact between a circumferential area of the spike member and the road surface is minimized while the tire rolls, thereby effectively preventing the spike member from bending at high speed running.

Fourth, a plurality of spike members are coupled to a synthetic resin belt at regular intervals, thereby preventing noise and lessening impact while running; effectively preventing the spike member from tangling; and decreasing weight to enhance convenience of mounting and portability.

Fifth, opposite ends of a belt having a plurality of spike members fixed thereto are detachably coupled with a length-adjustable fastener, so that it is convenient for a user to mount/remove the device on/from the tire and to more tightly fasten the device.

Sixth, a holding band member and a pair of hook rings are detachably coupled to externally surround a fastener, thereby effectively preventing a handle of the fastener from moving at high speed running.

### DESCRIPTION OF DRAWINGS

FIG. 1 is a perspective view of an anti-slipping device for dual tires, which is rolled out in a lengthwise direction by separating a spike member and a fastener.

FIGS. 2 through 4 are enlarged perspective views of “A”, “B” and “C” in FIG. 1, respectively.

FIGS. 5 through 7 are perspective views and a cross-sectional view of a spike member according to an embodiment of the present invention.

FIG. 8 is an exploded perspective view illustrating the connection between a spike member and a belt according to an embodiment of the present invention.

FIGS. 9 and 10 are perspective views illustrating coupling between a fastener and a belt according to an embodiment of the present invention.

FIG. 11 is an enlarged perspective view of a holding band member according to an embodiment of the present invention.

FIGS. 12 and 13 are perspective views illustrating coupling between a holding band member and first and second hook rings according to an embodiment of the present invention.

FIG. 14 illustrates that an anti-slipping device according to an embodiment of the present invention is applied to the dual tires.

### MODE FOR INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

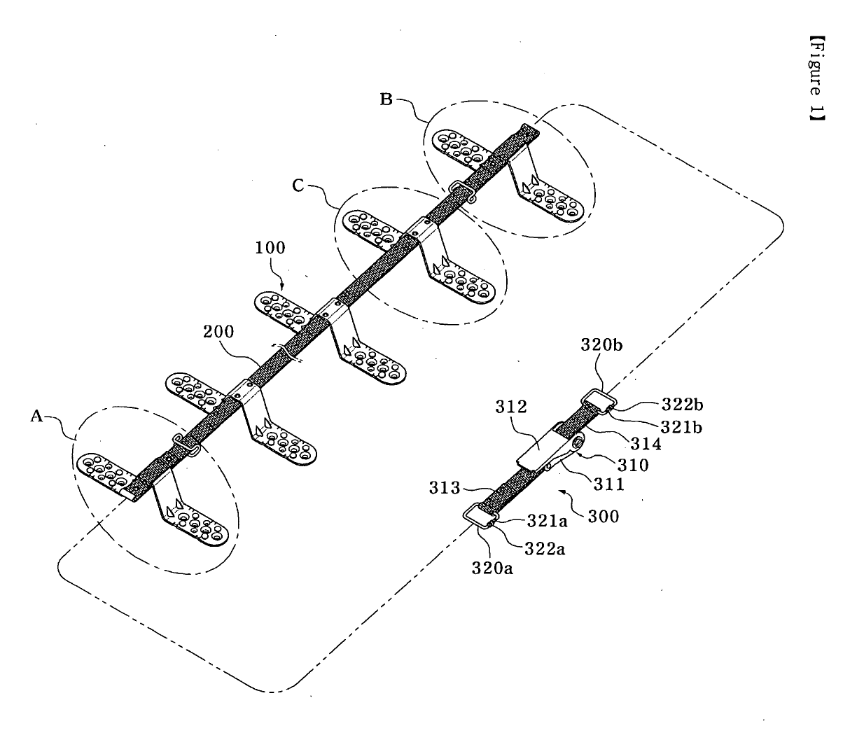

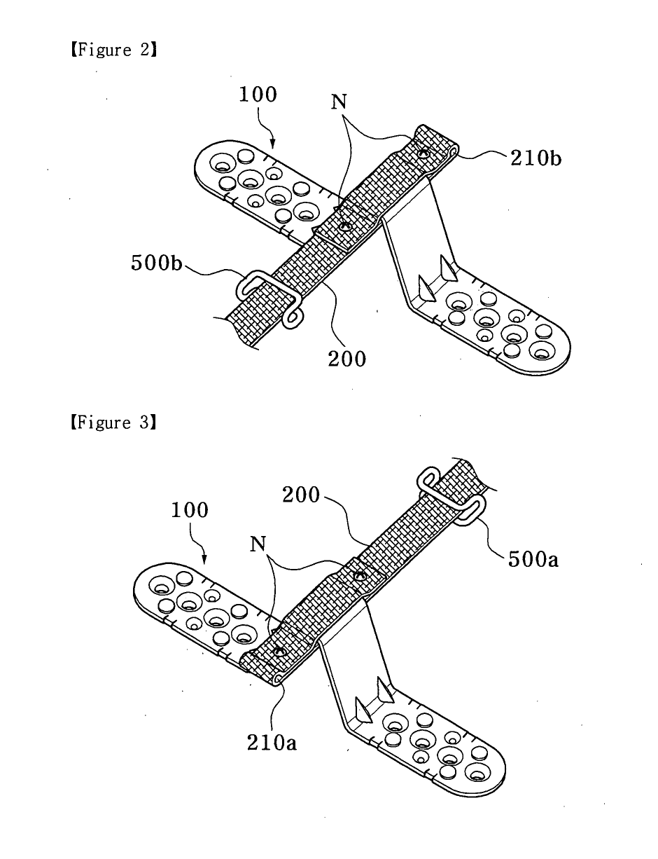

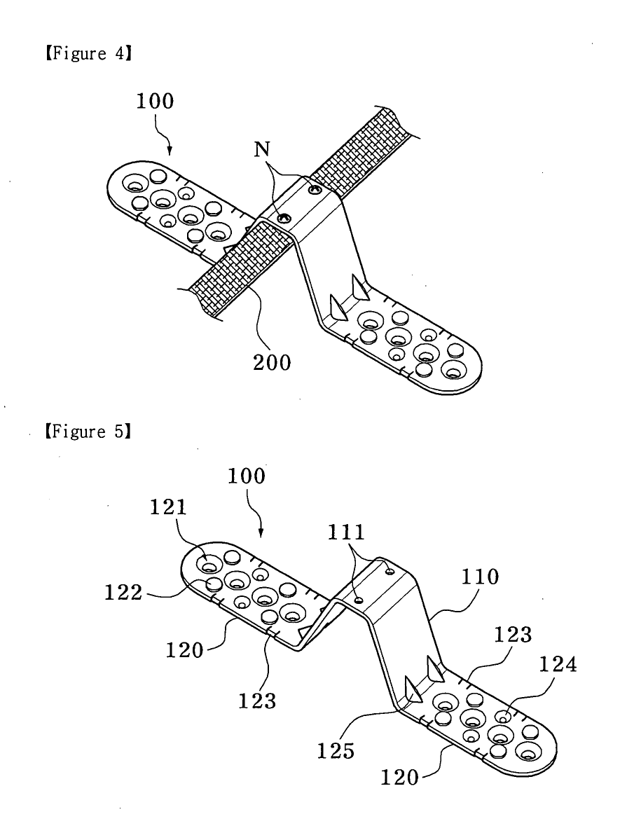

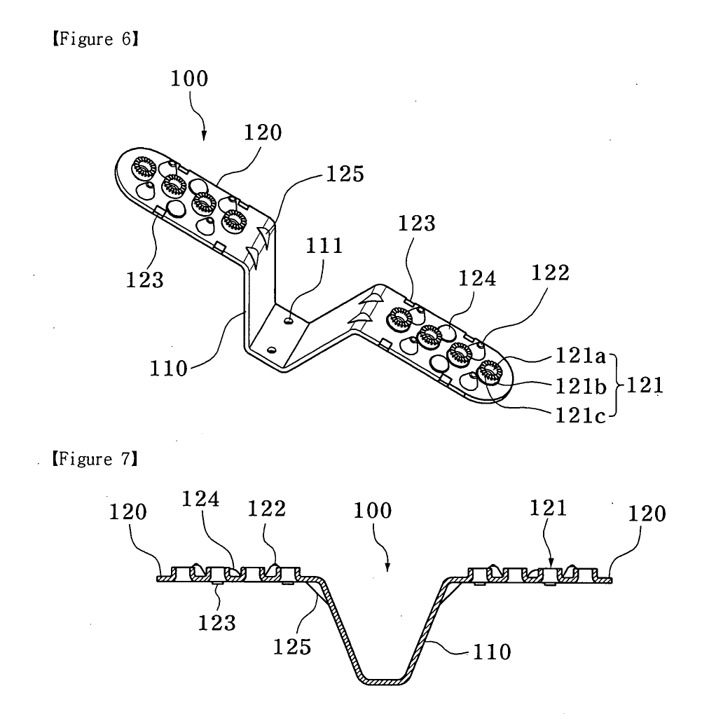

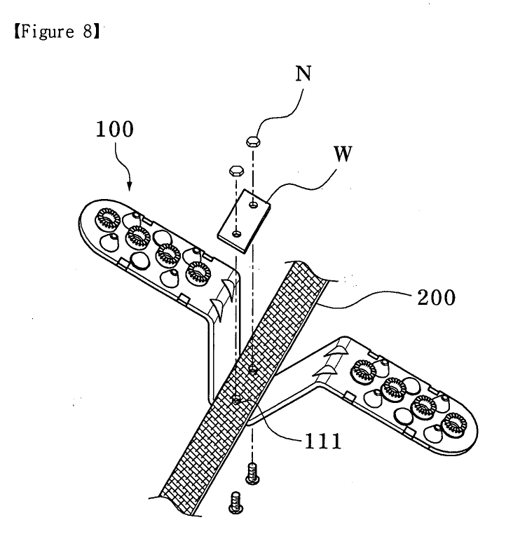

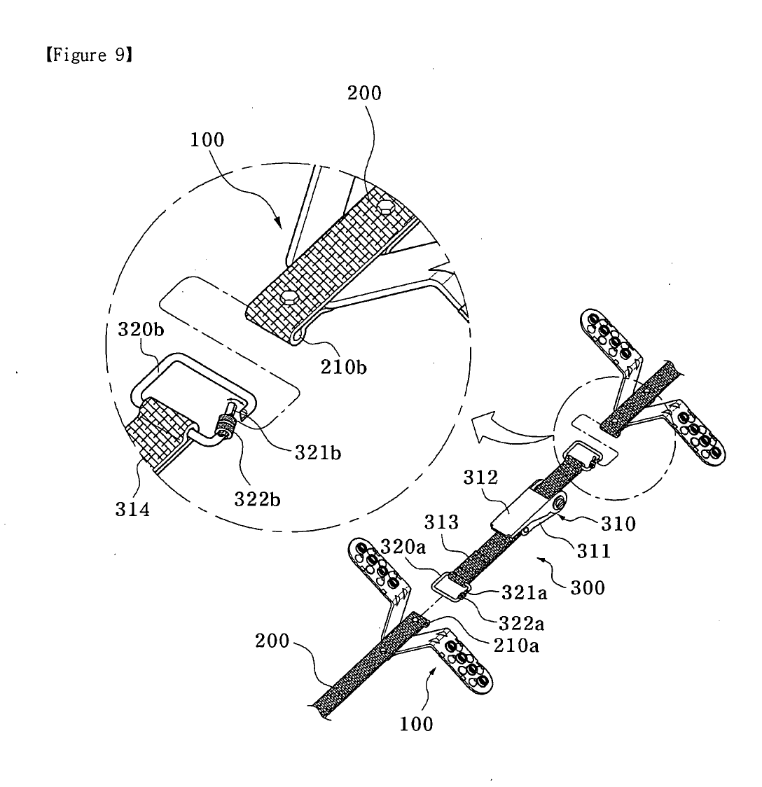

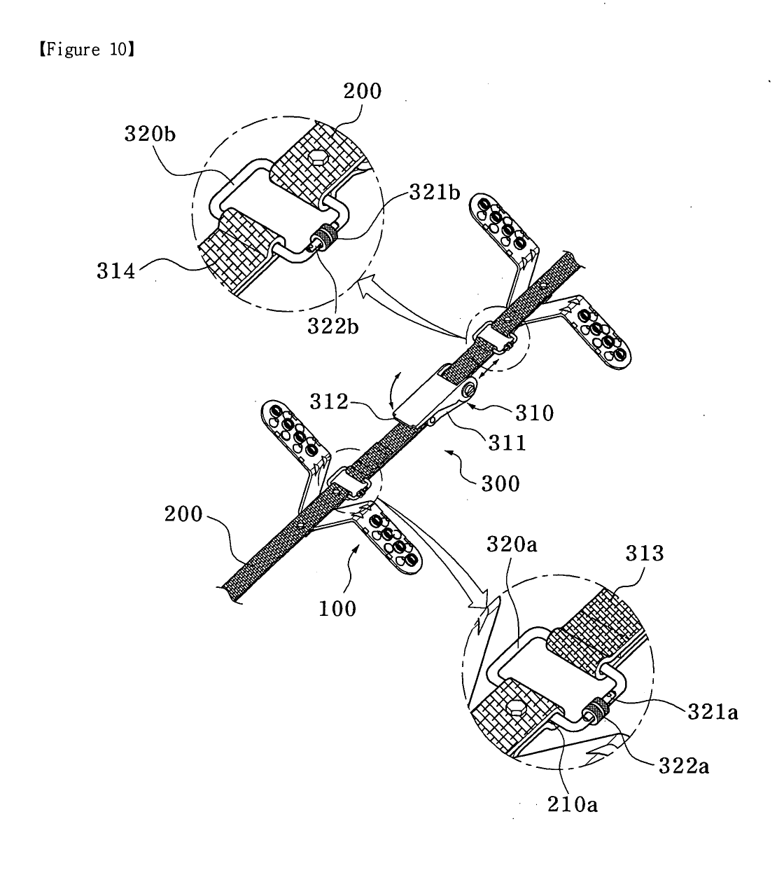

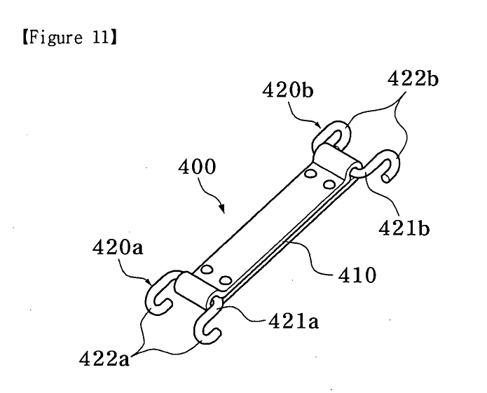

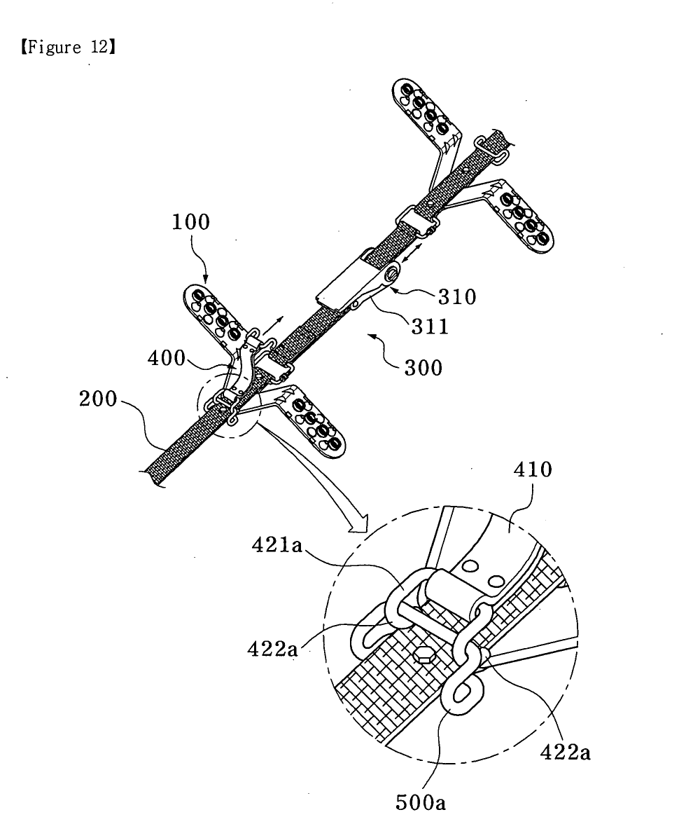

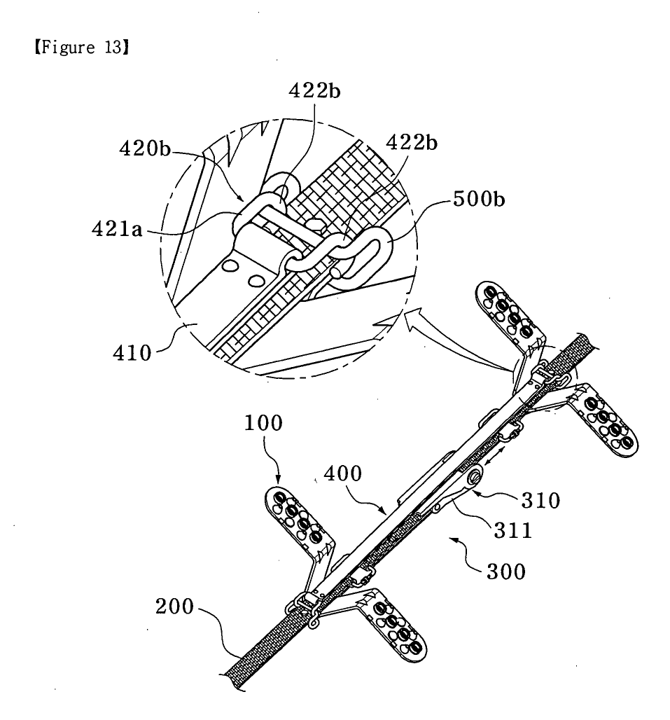

FIG. 1 is a perspective view of an anti-slipping device for dual tires, which is rolled out in a lengthwise direction by separating a spike member and a fastener; FIGS. 2 through 4 are enlarged perspective views of “A”, “B” and “C” in FIG. 1, respectively; FIGS. 5 through 7 are perspective views and a cross-sectional view of a spike member according to an embodiment of the present invention; FIG. 8 is an exploded perspective view illustrating the connection between a spike member and a belt according to an embodiment of the present invention; FIGS. 9 and 10 are perspective views illustrating coupling between a fastener and a belt according to an embodiment of the present invention; FIG. 11 is an enlarged perspective view of a holding band member according to an embodiment of the present invention; and FIGS. 12 and 13 are perspective views illustrating coupling between a holding band member and first and second hook rings according to an embodiment of the present invention.

Referring to FIGS. 1 through 11, an anti-slipping device for dual tires according to an embodiment of the present invention includes a plurality of spike members 100, a belt 200 connecting the spike members 100, and a fastener 300 detachably coupled to opposite ends of the belt 200 and adjusting tension of the belt 200.

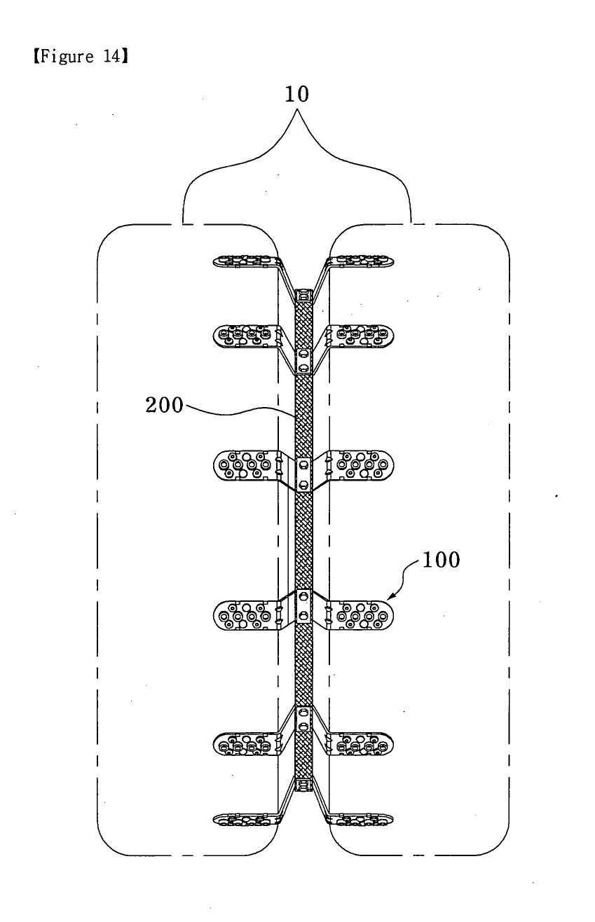

Here, the plurality of spike members 100 are shaped like a metal plate, and include an insertion plate 110 bent in a trapezoidal [symbol] shape in the middle thereof to be inserted between the dual tires 10 (refer to FIG. 14, which are used as a rear wheel of a large truck or the like), and a close-contact plate 120 integrally and flatly extending from opposite sides of the insertion plate 110 and closely contacting each surface of the dual tires 10.

At this time, a top surface of the insertion plate 110 of the spike member 100 is formed with at least one through hole 111 to be coupled with the belt 200 by a coupling unit such as a bolt, a nut, etc.

Further, a plurality of double spikes, i.e., first and second spikes 121 and 122 protrude from an outer surface (in contact with a road surface) of the close-contact plate 120 of the spike member 100 at regular intervals so as to be different in height, thereby enhancing friction with the road surface and preventing slipping.

In more detail, the plurality of first spikes 121 are arranged at regular intervals on the middle of the close-contact plate 120 in a lengthwise direction. The first spike 121 includes a hole 121a penetrating the close-contact plate 120, a projection 121b integrally protruding from a circumference of the hole 121a and having a cylindrical shape, and an uneven part 121c formed on a top surface (in contact with the road surface) of the projection 121b and shaped like a regular or irregular saw-tooth to increase friction with the road surface.

The plurality of second spikes 122 are fixedly coupled to the opposite sides of the close-contact plate 120 by a rivet between the first spikes 121. For example, the second spike 122 is formed of metal materials such as tungsten or the like, which has high stiffness and good abrasion resistance.

The plurality of second spikes 122 are stuck into snow or ice on the road, so that the friction between the road and the anti-slipping device increases, thereby effectively preventing the vehicle from slipping and consulting safety running of the vehicle.

Further, the plurality of second spike 122 are shaped like a cone, so that a contact rate between the road and the anti-slipping device is minimized, thereby rarely damaging the road surface to satisfy regulations of various countries (e.g., United States and so on).

Also, the second spike 122 protrudes higher than the first spike 121 by a predetermined height (preferably, about 1 mm-3 mm), so that the first spike 121 for anti-slipping on the snowy road is effectively prevented from abrasion on the way of running.

Additionally, the plurality of second spikes 122 are arranged not in a straight-line but in a zigzag pattern along a width direction of the close-contact plate 120, so that a scratch area becomes larger on the icy road, thereby maximizing the braking power.

Meanwhile, a circumference of the close-contact plate 120 of the spike member 100 is provided with a plurality of fitting parts bent at a predetermined angle to contact the surface of the tire, so that close-contact between the anti-slipping device and the tire increases, thereby preventing a wheel from idling and enhancing driving comfort.

Further, the outer surface of the close-contact plate 120 of the spike member 100, i.e., a contact surface in contact with the road surface is provided with at least one first curved part 124 such as an embossing pattern, so that contact between a circumferential area of the close-contact plate 120 of the spike member 100 and the road surface is minimized while the tire rolls, thereby effectively preventing the spike member from bending at high speed running.

Also, for example, a pair of second curved parts 125 each having a V-shape additionally protrude from opposite positions where the insertion plate 110 and the close-contact plate 120 of the spike member 100 are connected, thereby further effectively preventing the spike member 100 from bending at the high speed running.

With this configuration, the plurality of spike members 100 can be conveniently replaced piece by piece, so that it is semipermanently usable.

In the meantime, the belt 200 is made of a synthetic resin material. To increase tension, the belt 200 can be formed by stacking at least one synthetic resin material. It is preferable but not necessary, like a general flat belt, that the belt 200 includes a polyimid interior and a Nitrile-Butadiene Rubber (NBR) surface resistant to friction and abrasion.

As shown in FIGS. 2 and 3, the opposite ends of the belt 200 are formed with insertion spaces 210a and 210b in which first and second locking rings 320a and 320b of the fastener 300 to be described later are inserted.

The insertion spaces 210a and 210b may be formed by folding the end of the belt 200 by a predetermined length onto the belt 200 to cross over at least one spike member 100, and then fixedly fastening it with a bolt, a nut N, or the like.

The plurality of spike members 100 are coupled to the belt 200 having this configuration at regular intervals, thereby preventing noise and lessening impact while running; effectively preventing the spike member from tangling; and decreasing weight to enhance convenience of mounting and portability.

With regard to the coupling between the spike member 100 and the belt 200, as shown in FIG. 8, the belt 200 is coupled to the top surface of the insertion plate 110 of the spike member 100 by inserting at least one bolt, at least one nut N and at least one washer W into the through hole 111 formed on the insertion plate 110 of the spike member 100.

In this embodiment, the spike member 100 and the belt 200 are coupled by the bolt and the nut N, but not limited thereto. Alternatively, the spike member and the belt may be coupled by a typical rivet.

The fastener 300 includes a belt fastener 310, and first and second locking rings 320a and 320b. The belt fastener 310 includes a holding belt 313 and an adjusting belt 314, so that it is adjustable in length. The first and second locking rings 320a and 320b are detachably coupled to the holding and adjusting belts 313 and 314, respectively, so that they are releasably locked into the insertion spaces 210a and 210b formed in opposite ends of the belt 200.

Here, the belt fastener 310 includes a main body 311 forming a base body; a handle 312 rotatably coupled to the main body 311; and the holding and adjusting belts 313 and 314, which has the same configuration and effect as a typical tensioner for fastening luggages, so that the belt fastener 310 is schematically illustrated in the accompanying drawings. For instance, detailed configuration and description refer to Korean Utility Model No. 20-293775, entitled “Tensioner for Fastening Luggages”.

The first and second locking rings 320a and 320b have the same structure as a general karabiner that is a kind of mountaineering articles. The first and second locking rings 320a and 320b include first and second elastic locking parts 321a and 321b, and first and second locking knobs 322a and 322b, respectively. Each of the first and second elastic locking parts 321a and 321b is made of a metal body shaped like a ring, and hingedly opened and closed by elasticity of a spring. The first and second locking knobs 322a and 322b are rotated by a screw along the first and second elastic locking parts 321a and 321b, and selectively lock/release the first and second elastic locking parts 321a and 321b. Therefore, the first and second locking rings 320a and 320b are schematically illustrated in the accompanying drawings. For instance, detailed configuration and description refer to Korean Utility Model No. 20-409628, entitled “Karabiner”.

Meanwhile, as shown in FIGS. 9 and 10, the coupling between the fastener 300 and the belt 200 can be achieved by rotating the first and second locking knobs 322a and 322b of the first and second locking rings 320a and 320b coupled to the opposite ends of the fastener 300 in one direction to release the locked state of the first and second elastic locking parts 321a and 321b, and then inserting the first and second locking rings 320a and 320b into the insertion spaces 210a and 210b formed at the opposite ends of the belt 200 in the state that the first and second elastic locking parts 321a and 321b are opened by applying a predetermined pressure thereto.

Then, the first and second elastic locking parts 321a and 321b are released from the applied pressure, so that the first and second elastic locking parts 321a and 321b are returned to their original positions by a restoring force and thus closed. In this state, the first and second locking knobs 322a and 322b of the first and second locking rings 320a and 320b are rotated in the other direction, thereby maintaining the locked state of the first and second elastic locking parts 321a and 321b.

In addition, a holding band member 400 and first and second hook rings 500a and 500b are provided to prevent the handle 312 of the fastener 300 from moving.

The holding band member 400 is detachably coupled to the fastener 300 while covering the exterior of the fastener 300. As shown in FIG. 11, the holding band member 400 includes an expandable rubber band 410 having a predetermined length, and first and second connection rings 420a and 420b coupled to the opposite ends of the rubber band 410 by a typical rivet.

Here, the first and second connection rings 420a and 420b include first and second bodies 421a and 421b having [symbol] -shapes and coupled to the opposite ends of the rubber band 410; and first and second bending ends 422a and 422b integrally extending from opposite ends of the first and second bodies 421a and 421b and bent in U-shapes to be hooked to the first and second hook rings 500a and 500b.

Further, the first and second hook rings 500a and 500b are coupled to the belt 200 between two spike members 100 provided in the opposite ends of the belt 200 in the state that they are movable in the lengthwise direction of the belt 200, and are detachably coupled to the holding band member 400, so that the first and second hook rings 500a and 500b include rectangular rings perpendicularly curved at opposite ends thereof in a “Z,900 ”-shape.

With this configuration, the coupling between the holding band member 400 and first and second hook rings 500a and 500b is, as shown in FIGS. 12 and 13, achieved by hooking the first bending end 422a of the first connection ring 420a to the first hook ring 500a in the state that the first and second locking rings 320a and 320b the fastener 300 are inserted and fitted into the insertion spaces 210a and 210b provided at the opposite ends of the belt 200, and then hooking the second bending end 422b of the second connection ring 420b to the second hook ring 500b while pulling the rubber band 410. Thus, the fastener 300 is covered with the holding band member 400, so that the handle 312 of the fastener 300 can be effectively prevented from moving at high speed running.

FIG. 14 illustrates that an anti-slipping device according to an embodiment of the present invention is applied to the dual tires.

Referring to FIGS. 1 through 14, when the anti-slipping device is mounted on the dual tires 10, the insertion plate 110 of the spike member 100 is inserted between the dual tires 10 and at the same time the close-contact plate 120 closely contacts the surface of the tire. Then, the first and second locking rings 320a and 320b of the fastener 300 are inserted and fitted into the insertion spaces 210a and 210b formed at the opposite ends of the belt 200. Thereafter, the tension of the belt 200 is maintained by operating the handle 312 of the belt fastener 310.

In more detail, as shown in FIG. 1, in the state that the spike members 100 connected by the belt 200 are lengthwise rolled out on the road surface, one end of the belt 200 is put from the lower rear to the front of the dual tires, and then the insertion plate 110 of the spike member 100 is inserted between the dual tires 10 and the close-contact plate 120 closely-contact the surface of the tire while the dual tires are wrapped with the spike members 100.

Then, the first and second locking rings 320a and 320b of the fastener 300 are inserted and fitted into the insertion spaces 210a and 210b of the belt 200, and then the handle 312 of the belt fastener 310 is repeatedly rotated to thereby maintain the tension of the belt 200.

Last, the first and second connection rings 420a and 420b of the holding band member 400 are hooked to the first and second hook rings 500a and 500b, so that the fastener 300 is covered with the holding band member, thereby effectively preventing the handle 312 of the fastener 300 from moving at the high speed running.

While the invention has been shown and described with reference to certain exemplary embodiments thereof, it will be understood by those skilled in the art that various changes in form and details may be made therein without departing from the spirit and scope of the invention as defined by the appended claims.

1. An anti-slipping device for dual tires comprising:
a plurality of spike members 100 which comprises an insertion plate 110 bent in a trapezoidal shape to be inserted between the dual tires 10, and a close-contact plate 120 integrally and flatly extending from opposite sides of the insertion plate 110 to closely contact each surface of the dual tires 10;
a belt 200 connecting the insertion plates 110 of the plurality of spike members 100 to each other; and
a fastener 300 detachably coupled to opposite ends of the belt 200 to adjust tension of the belt,
wherein a plurality of first and second spikes 121 and 122 protrude from an outer surface of each close-contact plate 120 of the plurality of spike members 100 at regular intervals to be different in height from each other to prevent friction with a road surface and slipping.

2. The anti-slipping device according to claim 1, wherein the plurality of first spikes 121 are lengthwise arranged on a middle of the close-contact plate 120 at regular intervals, and comprises a hole 121a penetrating the close-contact plate 120 and a cylindrical projection 121b integrally protruding from an outer circumference of the hole 121a.

3. The anti-slipping device according to claim 2, wherein a top surface of the projection 121b is formed with an uneven part 121c having a regular or irregular saw-tooth for increasing friction with the road surface.

4. The anti-slipping device according to claim 1, wherein the plurality of second spikes 122 are provided higher than the plurality of first spikes 121 by a predetermined height.

5. The anti-slipping device according to claim 4, wherein the predetermined height ranges from 1 mm to 3 mm.

6. The anti-slipping device according to claim 1, wherein the plurality of second spikes 122 have a cone shape to minimize a contact rate with the road surface.

7. The anti-slipping device according to claim 1, wherein the plurality of second spikes 122 are arranged in a zigzag pattern between the plurality of first spikes 121.

8. The anti-slipping device according to claim 1, wherein an outer circumference of the close-contact plate 120 of the spike member 100 is provided with a plurality of fitting parts 123 bent to contact the surface of the tire for anti-slipping and close-contact.

9. The anti-slipping device according to claim 1, wherein the outer surface of the close-contact plate 120 of the spike member 100 is provided with at least one protruded first curved part 124 formed in an embossing pattern to prevent the spike member from bending.

10. The anti-slipping device according to claim 1, wherein a pair of second curved parts 125 each having a V-shape protrude from opposite positions where the insertion plate 110 and the close-contact plate 120 of the spike member 100 are connected, to prevent the spike member 100 from bending.

11. The anti-slipping device according to claim 1, wherein the fastener 300 comprises
a belt fastener 310 comprising a holding belt 313 and an adjusting belt 314 and having an adjustable length; and
first and second locking rings 320a and 320b detachably coupled to the holding and adjusting belts 313 and 314, respectively, to be releasably locked into the insertion spaces 210a and 210b formed in opposite ends of the belt 200.

12. The anti-slipping device according to claim 1, further comprising
a holding band member 400 detachably coupled to the fastener 300 while covering an exterior of the fastener 300 and preventing the fastener 300 from moving; and
first and second hook rings 500a and 500b lengthwise movably coupled to the belt 200 between two spike members 100 provided in the opposite ends of the belt 200, and detachably coupled to the holding band member 400.

13. The anti-slipping device according to claim 12, the holding band member 400 comprises:
an expandable rubber band 410 having a predetermined length; and
first and second connection rings 420a and 420b fixedly coupled to opposite ends of the rubber band 410,
wherein the first and second connection rings 420a and 420b comprise first and second bodies 421a and 421b having “z,900 ”-shapes and fixedly coupled to the opposite ends of the rubber band 410; and first and second bending ends 422a and 422b integrally extending from opposite ends of the first and second bodies 421a and 421b and bent in U-shapes to be hooked to the first and second hook rings 500a and 500b.

14. The anti-slipping device according to claim 12, wherein the first and second hook rings 500a and 500b comprise rectangular rings perpendicularly curved at opposite ends thereof to have a “z,900 ”-shape.
